(19) United States
(12) Patent Application Publication
(10) Pub. No.: US 2013/0071683 A1
(43) Pub. Date: Mar. 21, 2013

(54) SYSTEMS AND METHODS FOR ELECTROFORMING DOMES FOR USE IN DOME SWITCHES

(71) Applicants: John C. DiFonzo, Redwood City, CA (US); Michael Hillman, Los Altos, CA (US); Christiaan Ligtenberg, San Carlos, CA (US); Gregory Tice, Los Altos, CA (US)

(72) Inventors: John C. DiFonzo, Redwood City, CA (US); Michael Hillman, Los Altos, CA (US); Christiaan Ligtenberg, San Carlos, CA (US); Gregory Tice, Los Altos, CA (US)

(73) Assignee: APPLE INC., Cupertino, CA (US)

(21) Appl. No.: 13/238,461

(22) Filed: Sep. 21, 2011

(51) Int. Cl. C25D 1/00; B32B 3/28

(52) U.S. Cl. 428/603; 205/50; 205/78

(57) ABSTRACT

Systems and methods are provided for electroforming a dome for use in a dome switch. A mandrel having several dome shapes incorporated in a planar surface is provided. The mandrel can serve as a cathode in an electroforming process to construct a sheet of domes, for example by enabling the deposition of a sheet of nickel on the mandrel. The domes can be singulated from the sheet for use as part of dome switches. The electroforming process may ensure that the domes have a uniform thickness and no internal stresses that may affect the performance of the domes.

### BACKGROUND OF THE INVENTION

Different approaches can be used in an electronic device to convert a user's physical press of a button or key to an electrical signal. In some cases, one or more dome switches can be provided underneath the button or key such that when the button or key is pressed, the dome switch may close an electrical circuit. In particular, each dome switch can include a metal dome that is positioned over contact pads such that, when the metal dome is inverted, it comes into contact with the contact pads and closes a circuit between the contact pads. Typically, the domes of dome switches are constructed by stamping metal sheets (e.g., sheets of steel), or by molding an elastomer (e.g., silicone).

While dome switches can be cheap and reliable, they may have some drawbacks. First, the proper operation of a stamped metal dome depends on a number of factors including, for example, the stamping process and tool, the sheet thickness, material grain, alloy composition, and heat treatment. Because some of these factors may be difficult to control, resulting domes may vary in actuation force, and therefore require force tolerance requirements that allow for large variations. This may be especially burdensome for domes constructed to actuate under low dome force. In addition, dome switches having stamped domes may require a central nub positioned over the dome switch and beneath a button or key to center the force applied to the dome. This additional nub may increase the cost of the dome switches. Further, the tactile snap provided by the dome switch may depend on work hardening of the metal that is stamped to construct the switch. Work hardening, however, can be difficult to control and to predict, and therefore can require a time-consuming and expensive trial and error process. As a final illustrative drawback, domes constructed from an elastomer such as silicone may not operate properly with very low travel.

### SUMMARY OF THE INVENTION

This is directed to systems and methods for electroforming snap domes for use in dome switches.

To eliminate some of the drawbacks described above, a different process can be used to construct domes used in dome switches. In particular, an electroforming process can be used. In an electroforming process, material is deposited onto a mandrel via a chemical bath. Material is deposited with sufficient thickness to create a self-supporting structure that may be later removed from the mandrel. Because the material is evenly deposited on the mandrel, the resulting domes may have predictable and expected mechanical properties.

The mandrel can have any shape suitable for constructing a snap dome for use in a dome switch. In some cases, the mandrel can include a planar surface from which dome shapes extend. The dome shapes can include shapes having smooth outer surfaces that extend perpendicular to the planar surface of the mandrel. For example, the dome shapes can include portions of a sphere extending out of the planar surface. In some cases, the dome shapes can be constructed as a spline or curve that is rotated around an axis perpendicular to the planar surface.

The mandrel can include any suitable number of dome shapes. In some cases, the mandrel can include dome shapes distributed in an even manner and at a relatively high density. In particular, it may be desirable to reduce to space between dome shapes so that minimal amounts of material are wasted between the domes. The dome shapes can have any suitable size or shape on the mandrel. For example, the mandrel can include dome shapes of a single size and shape, or a variety of sized and shaped dome shapes.

Once an electroformed sheet has been constructed using the mandrel, any suitable approach can be used to singulate domes from the sheet. For example, a complementary electrochemical etching process can be used. Alternatively, the domes can be singulated using a photo-etching process. As another example, domes can be singulated using laser cutting, a water jet, or machining. Each individual dome can then be mounted as part of a dome switch and used in an electronic device.

### BRIEF DESCRIPTION OF THE FIGURES

The above and other objects and advantages of the invention will be apparent upon consideration of the following detailed description, taken in conjunction with the accompanying drawings, in which like reference characters refer to like parts throughout, and in which:

FIG. 1A is a sectional view of an illustrative dome switch;

FIG. 1B is a sectional view of the illustrative dome switch of FIG. 1A when the dome switch is actuated;

FIGS. 2A-C are views of illustrative domes for use in dome switches;

FIG. 3 is a schematic view of an illustrative electroforming process in accordance with some embodiments of the invention;

FIG. 4 is a perspective view of an illustrative mandrel for use in an electroforming process in accordance with some embodiments of the invention; and

FIG. 5 is a perspective view of an illustrative sheet of electroformed domes in accordance with some embodiments of the invention;

FIG. 6 is a sectional view of material deposited over a mandrel to form domes in accordance with some embodiments of the invention;

FIG. 7 is a graph of measured actuation force and return force for actuations of a stamped dome;

FIG. 8 is a graph of measured actuation force and return force for actuations of an electroformed dome in accordance with some embodiments of the invention;

FIG. 9 is a flowchart of an illustrative process for electroforming a dome switch in accordance with some embodiments of the invention;

FIG. 10 is a flowchart of an illustrative process for constructing a mandrel for use in an electroforming process in accordance with some embodiments of the invention; and

FIG. 11 is a flowchart of an illustrative process for making an electroformed dome in accordance with some embodiments of the invention.

### DETAILED DESCRIPTION OF THE INVENTION

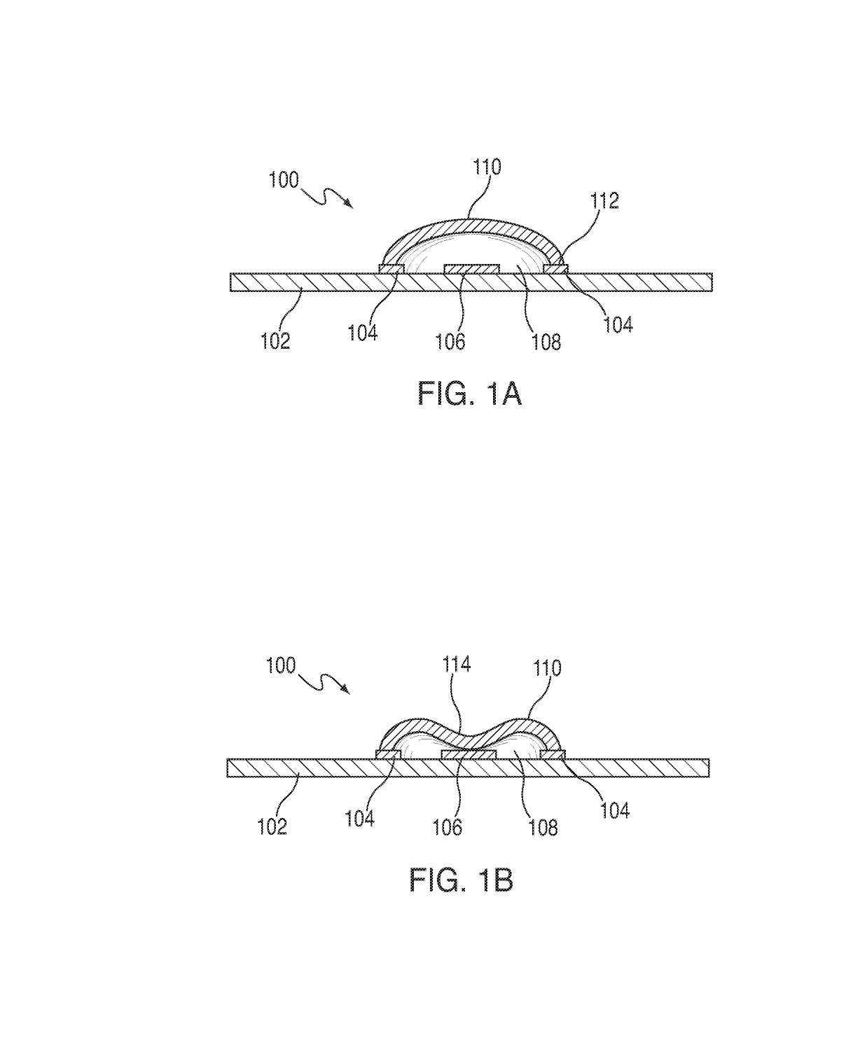

Dome switches are commonly used to detect inputs of a user. A dome switch includes a deformable dome (e.g., a snap dome) placed over contact regions. FIG. 1A is a sectional view of an illustrative dome switch. FIG. 1B is a sectional view of the illustrative dome switch of FIG. 1A when the dome switch is actuated. Switch 100 can include substrate 102 (e.g., a circuit board) on which the switch is mounted. Several conductive paths can be constructed on or within substrate 102 to conduct signals between electronic components. One or more of the conductive paths can include contact pads 104 and 106 that are exposed on a surface of substrate 102. For example, contact pads 104 and 106 can include copper pads that are etched on a surface of substrate 102. In some cases, however, switch 100 can operate without requiring actual physical contact, but rather can detect changes in capacitance, or in other detectable physical conditions.

Each of contact pads 104 and 106 can have any suitable shape and/or dimension. In some cases, contact pad 104 can include one or more segments that form a circular or closed loop. For example, contact pad 104 can include four distinct segments that form part of a circle (e.g., four segments each defining a 60 degree arc segment). As another example, contact pad 104 can include a single segment forming a closed circle. Contact pad 104 can have any suitable width (e.g., measured within the plane of substrate 102). In some cases, the width can be selected based on properties or dimensions of the dome (e.g., dome 110, described in more detail below) placed in contact with contact pad 104. Contact pad 104 can have any suitable height or thickness (e.g., measured perpendicular to the surface of substrate 102). In some cases, the thickness of contact pad 104 can be selected based on a desired lifespan for dome switch 100. For example, if it is desired that dome switch 100 last for at least 1 million cycles, contact pad 104 can have a thickness selected such that the material of contact pad 104 has not been worn away after 1 million presses of dome 110 into contact pad 104.

To close an electrical circuit using dome switch 100, contact pad 106 can be positioned such that it is electrically isolated from contact pad 104 when dome switch 100 is not closed. For example, contact pad 106 can be separated from contact pad 104 by region 108. To close the circuit, therefore, a conductive path may need to be provided between contact pad 104 and contact pad 106, bypassing region 108.

To close the circuit, dome switch 100 can include dome 110 positioned over contact pad 104. In particular, a periphery 112 of dome 100 can be aligned with contact pad 104 such that periphery 112 comes into contact with contact pad 104. In its non-actuated position (e.g., FIG. 1A), dome 110 can form a concave structure that is offset from contact pad 106. In its actuated position (e.g., FIG. 1B), dome 110 can be deformed and exhibit a convex region 114 such that portion 116 of dome 110 comes into contact with contact pad 106. The resulting contact between portion 116 and contact pad 106 can create a conductive path between contact pads 104 and 106 through dome 110. This may require, however, that dome 110 be constructed from a conductive material (e.g., a metal), or that an internal surface of dome 110 is coated with a conductive material.

Domes 110 can be used in a binary context, such as a switch, or in an analog context. In the analog context, domes 110 may be used in sensor applications such as a pressure sensor, force sensor, or a capacitive sensor.

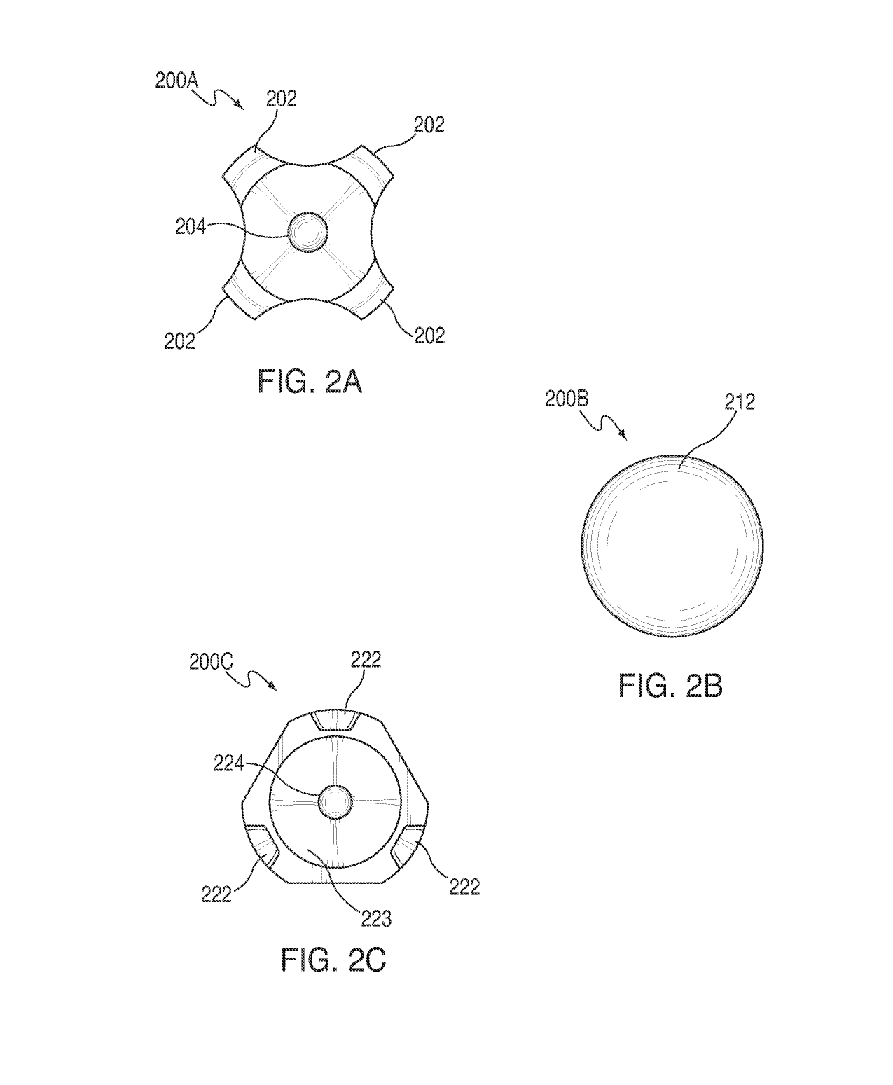

Dome 110 can have any suitable shape provided that it includes at least one portion that is placed in contact with contact pad 104, and at least one portion that can be displaced to come into contact with contact pad 106. FIGS. 2A-C are views of illustrative domes for use in dome switches. Dome 200A can include several extensions 202 surrounding a circular center region 203. Extensions 202 may be constructed to come into contact with contact pad 104. Dome 200A can include central nub 204 for coming into contact with pad 106. Dome 200B can include a regular, circular shape (e.g., a portion of a surface of a sphere) such that periphery 212 of the dome can come into contact with a circular contact pad 104. Dome 200C can include a substantially triangular shape, where vertices 222 of the triangle come into contact with contact pad 104. Nub 224, at the center of circular region 223, can come into contact with contact pad 106 when dome 200C is deflected.

Domes such as those used in dome switches can be constructed using different approaches. A typical approach includes stamping a pre-formed metal sheet to impart the dome shape to the sheet. As discussed above, however, this approach may have some drawbacks. In particular, providing many domes that require a consistent actuation force may be difficult via stamping. Furthermore, stamped domes require an additional, plastic component forming a nub placed over the apex of the dome to help direct the force applied to the dome. In addition, the snap effect of each stamped dome may depend on the work hardening provided for each region of the sheet of material that is stamped. Different sheets, and even different regions of a single sheet can have different work hardening properties, and therefore provide different snap effects.

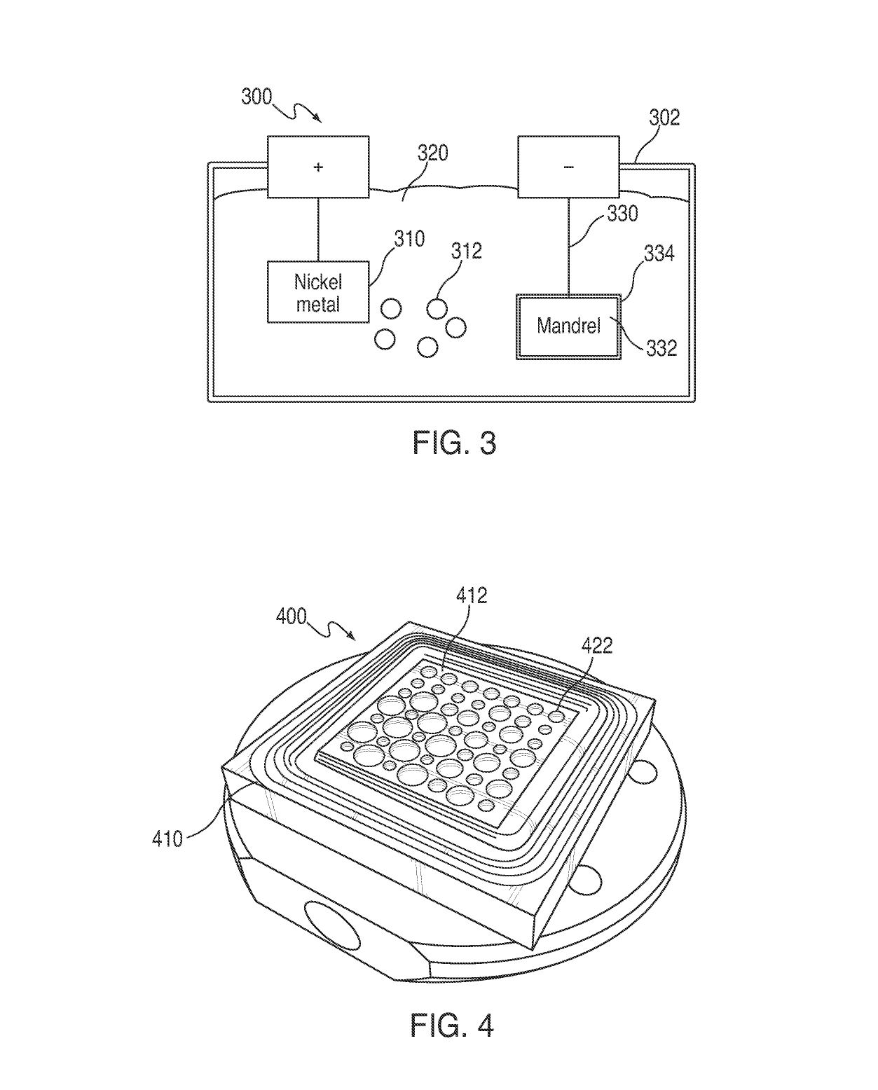

A different approach may therefore be desirable in an attempt to better control one or more of the factors that affect the performance of domes. For example, it may be desirable to construct domes using a process that allows for a consistent or predictable sheet or dome thickness, material grain, alloy composition, and work hardening. One such approach can include electroforming. FIG. 3 is a schematic view of an illustrative electroforming process in accordance with some embodiments of the invention. Process 300 is used to form thin components that are self-supporting when removed from a mandrel defining a support structure for the components. In an electroforming process, material 312 from anode 310 is moved in bath 320 towards mandrel 332 forming cathode 330 when an electric current 302 is applied between anode 310 and cathode 330. Material 312 may be deposited as a thin layer 334 on a surface of mandrel 332.

Any suitable material can be used as anode 310 to be deposited on mandrel 332. In some cases, anode 310 can include a nickel-based metal or alloy such that nickel is the primary material deposited on mandrel 332. In addition, any suitable material can be used for mandrel 322. In particular, the material can be selected such that layer 334 may be easily removed from mandrel 332 when layer 334 is sufficiently thick to be self-supporting. For example, mandrel 332 can be constructed from steel. As another example, mandrel 332 can be constructed from a non-conductive material that has a conductive coating. As still another example, mandrel 332 can be constructed from aluminum, which can be easily dissolved while leaving layer 334 remaining.

The electroforming process can have several advantages or benefits in constructing domes for dome switches. For example, the exact composition of the material deposited on the mandrel can be known and controlled by choosing the material for anode 310. In particular, it may be possible to ensure that a high percentage of the material deposited on mandrel 332 is pure nickel. For example, the nickel purity of layer 334 (i.e., the resulting component) may be larger than 95%, larger than 98%, larger than 99%, larger than 99.5%, larger than 99.8%, or larger than 99.9%. By providing a very pure electroformed component, or at least an electroformed component having a known chemical composition, alloy variations in the component may be reduced and the mechanical response of the component can be easily predicted and calculated based on the mechanical properties of the chemical composition.

Another related benefit can include knowing the mechanical and material properties of an electroformed component. In particular, the electroformed component will not include any work hardening or heat treatment (i.e., unlike a sheet of material that is stamped), and thus will have an unstressed and unstrained structure. In addition, the grain of the material will not include any unexpected or undesired discontinuities or singularities. As still another benefit, the electroformed component will not include any stresses or strains caused by a manufacturing process (e.g., rolling or stamping). The resulting electroformed component will therefore react in a manner that is predictable and can be easily calculated using classical mechanics, quantum mechanics, finite element analysis, or any other analytical means. This approach thus enables engineers to rationally design a dome to have particular mechanical properties, and to produce a dome that behaves as designed.

Still another benefit of an electroforming process can include a high degree of precision in the thickness of the electroformed component. In particular, by virtue of the bath, material from the anode is evenly deposited on the mandrel. The particular thickness of the deposited material is determined, for example, from the amount of current applied between the anode and the cathode, chemical properties of the bath, chemical properties of the anode and cathode, the amount of time that the mandrel is left in the bath, the amount of time that current is applied between the anode and the cathode, or combinations of these. These factors, however, can be easily controlled and repeated between batches to ensure that all electroformed components have substantially the same thickness. Electroformed domes can have any suitable thickness including, for example, a thickness in the range of 15 to 800 microns, 15 to 500 microns, 15 to 100 microns, 15 to 50 microns, 15 to 30 microns, or 15 to 20 microns.

In addition, because the nickel or other material is deposited atom by atom in a tightly controlled chemical and physical environment, variations in the thickness of the deposited material can be tightly controlled. For example, the tolerance for deposited material can be +/−1500 nanometers, +/−1000 nanometers, +/−500 nanometers, +/−200 nanometers, +/−100 nanometers, +/−50 nanometers, +/−30 nanometers, or +/−10 nanometers. This may ensure that the required actuation force is as predicted or designed, as the force varies as the cube of thickness (i.e., the thickness of the dome has a large effect on actuation force accuracy). In addition, this may enable the deposition of additional material in specific regions of the dome, for example to create a nub. For example, portions of the dome surrounding a center region can be masked, and additional material can be deposited over the mask such that when the mask is removed, the dome has additional material defining a nub.

A further benefit of the electroforming process may be the use of nickel for the domes instead of steel. Nickel can have a much higher tensile strength than some stainless steel alloys (e.g., 500 MPa for steel, but 2000 MPa for nickel), and therefore can potentially produce a more reliable part. In addition, a nickel dome may have a longer lifetime (e.g., more than one million actuations) than a comparatively thick steel dome. For example, a nickel dome may be less likely to fail than a steel dome having the same thickness.

The electroforming process may also reduce costs by eliminating the need for a distinct and separate nub placed on a stamped dome. Instead, the mandrel used to define the shape of the dome can include a nub that is incorporated in the dome, for example substantially at or near an apex of the dome. In this approach, there is no need to construct a separate nub, nor is there any need to position and secure the separate nub to the dome. Alternatively, the mandrel can be constructed to include a nub extending from a surface of the dome shape so that material deposited over the mandrel as part of an electroforming process may include the nub.

The mandrel used in the electroforming process can have any suitable feature for enabling the construction of a dome. FIG. 4 is a perspective view of an illustrative mandrel for use in an electroforming process in accordance with some embodiments of the invention. Mandrel 400 can include base structure 410 having top surface 412 on which electroformed material is deposited. Top surface 412 can include different features that correspond to the component that is electroformed. For example, top surface 412 can include several dome shapes 422 defining an inner surface for domes that will be formed by material plated over dome shapes 422. The dome shapes can be distributed in any suitable manner including, for example, in an even or regular distribution.

Dome shapes 422 can include three-dimensional shapes that extend out of the plane of top surface 412. For example, dome shapes 422 can include a spline that is revolved around an axis perpendicular to the plane of top surface 412. As another example, dome shapes 422 can include a portion of a sphere extending from the plane of top surface 412 (e.g., so that a resulting electroformed dome forms a portion of a surface of a sphere). In some cases, dome shapes 422 can include a smooth three-dimensional shape or surface. For example, a plane of at least one surface other than a surface along the thickness of the shape may vary (e.g., a plane of the inner surface or of the outer surface of the dome may vary). As another example, dome shapes 422 can include a surface that is curved over three dimensions. The dome shapes 422 can therefore include a closed periphery disposed in a plane (e.g., the portions of the dome that are in the plane of top surface 412) and a smooth and continuous structure extending out of the plane of the closed periphery.

Mandrel 400 can include any suitable number of dome shapes 422, each having any suitable property. For example, dome shapes 422 can all have the same diameter, shape, size, height, or other geometric property. In some cases, a single mandrel 400 can include dome shapes 422 corresponding to different types of dome switches, or dome switches having different properties (e.g., dome switches requiring different actuation forces or different travel). For example, mandrel 400 can include dome shapes 422 corresponding to all of the domes required for dome switches in a particular number of electronic devices (e.g., all of the domes required for constructing one, five, fifty, or one hundred devices). In some cases, a single mandrel 400 can include dome shapes 422 corresponding to a single type of dome switch. As another example, mandrel 400 can include one or more domes that can form a single part such as a keypad.

It may be desirable to provide a mandrel 400 with a high density of dome shapes to render the manufacturing process of domes more efficient (e.g., provide as many or more domes on mandrel 400 as are typically provided in a sheet of steel using a stamping process). In addition, it may be desirable to reduce or limit the space between adjacent dome shapes 422 to reduce the waste in deposited material between domes.

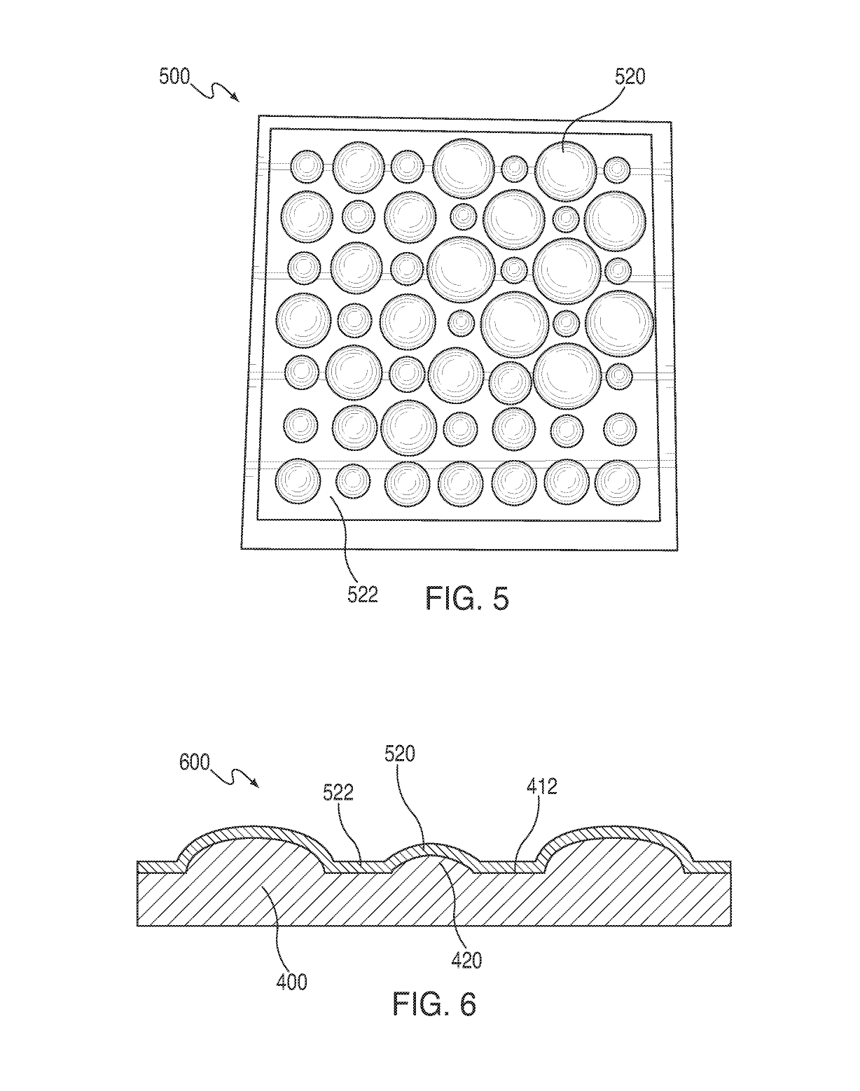

FIG. 5 is a perspective view of an illustrative sheet of electroformed domes in accordance with some embodiments of the invention. FIG. 6 is a sectional view of material deposited over a mandrel to form domes in accordance with some embodiments of the invention. Sheet 500 can correspond to top surface 412 of mandrel 400 (FIG. 4) over which nickel was deposited as part of an electroforming process. Sheet 500 can include domes 520 distributed on sheet 500 (e.g., distributed in accordance with the pattern of dome shapes on mandrel 400). Domes 520 can be distinguished from each other by intermediate material 522 that was deposited on portions of mandrel 400 that did not include dome shapes 422 (FIG. 4). By virtue of the electroforming process, each dome 520 can have a substantially identical thickness, and thus a predictable response to applied forces.

In some cases, additional material can be plated or deposited over the sheet of domes. For example, sheet 500 can be placed in an electroplating bath to coat a surface of domes (e.g., an interior surface of domes) with a highly conductive material (e.g., gold). In some cases, the additional material can be plated once the individual domes 520 have been removed from sheet 500. It will be understood, however, that in some cases it may be beneficial to provide a sheet of domes with pre-defined spacing (e.g., to provide a keypad). In such cases, the singulating approach may instead not be necessary, or may include separating collections of domes from one another.

Any suitable approach can be used to remove or separate domes 520 from sheet 500 (i.e., singulate the domes). In some cases, the domes can be singulated by using a complementary electrochemical etching process. Alternatively, the domes can be singulated using a photo-etching process. As another example, domes can be singulated using laser cutting or machining. The excess material between or surrounding the singulated domes (e.g., intermediate material 522) can be processed and re-used as part of or with an anode in additional electroforming processes (e.g., to form a new batch of domes). In this manner, waste can be minimized, which in turn reduces cost and limits the impact of the process on the environment.

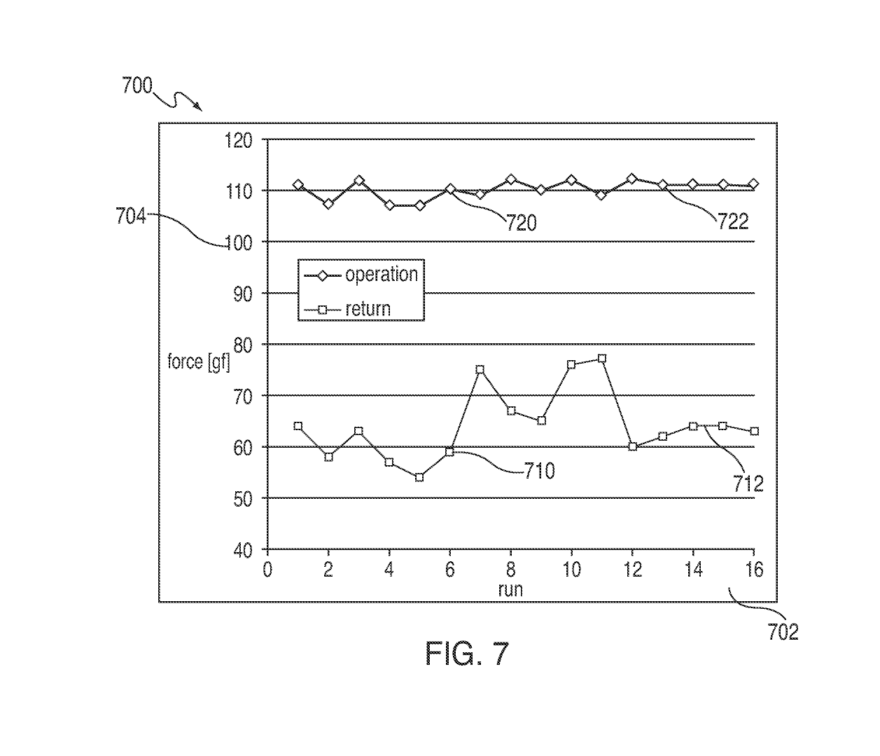

One benefit of domes constructed using an electroforming process may be that the long term actuating force and/or return force of the dome can be determined at the first actuation. In contrast, domes constructed from stamping exhibit a “work-in” effect in which the actuation force and the return force vary by substantial amounts for the first twenty or so actuations. After the “work-in” actuations, the stamped domes reach their long-term actuation and return forces. FIG. 7 is a graph of measured actuation force and return force for actuations of a stamped dome. Graph 700 includes horizontal axis 702 depicting actuations of a dome, and vertical axis 704 depicting a measured force. When a dome is actuated, the force required to depress the dome is measured and plotted on graph 700, and the return force of the dome when the pressing force is released is measured and plotted on graph 700.

The measured return force, shown as line 710, varies between approximately 55 (fifth actuation) and 78 (eleventh actuation) as the dome is initially actuated. It isn't until the fourteenth actuation that the return force reaches a substantially stable or long-term value of approximately 63, as indicated by flat portion 712 of line 710. Similarly, the measured actuation force, shown as line 720, varies between approximately 105 (second actuation) and 115 (third actuation) until the fourteenth actuation, where the measured force reaches a substantially steady-state or long term actuation force of 111 (e.g., indicated by substantially flat portion 722 of line 720). Because of this work-in effect, it may not be possible to know whether a stamped dome satisfies manufacturing requirements until the dome has been actuated enough to overcome the work-in effect (e.g., twenty actuations). This takes time, which in turn can be expensive.

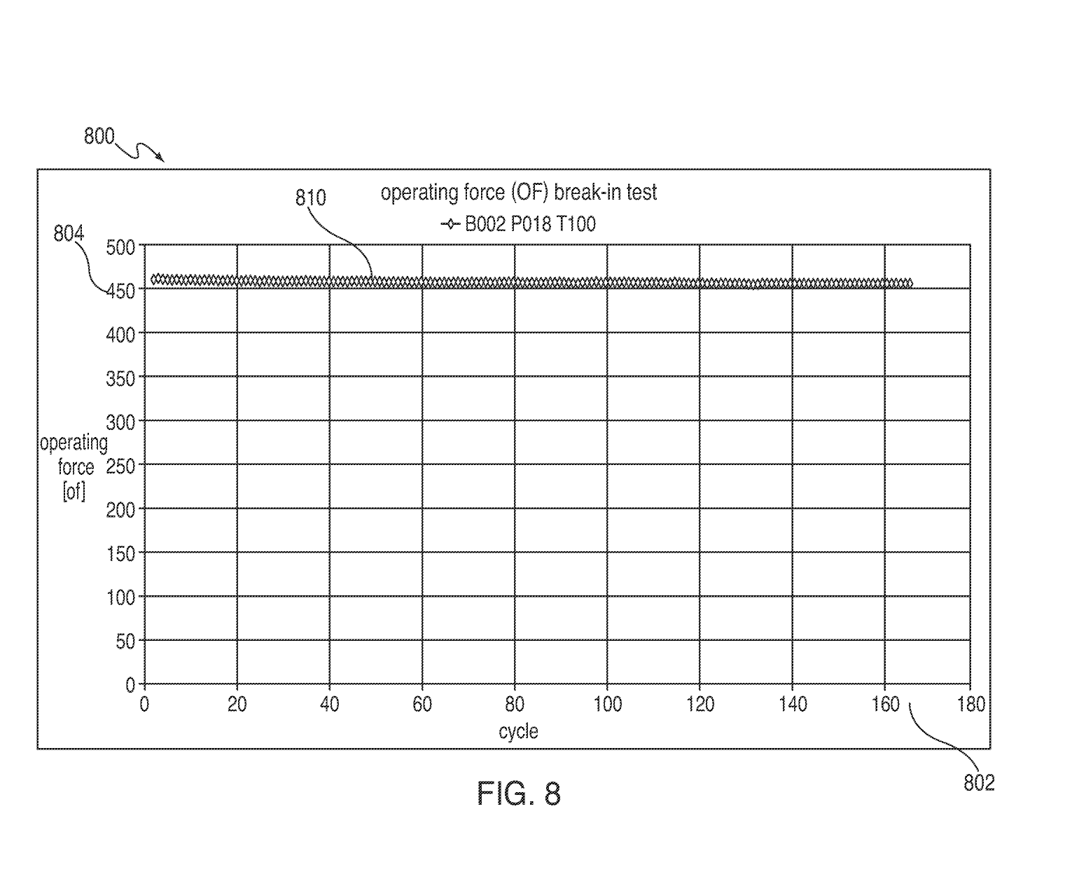

In contrast with stamped domes, electroformed domes provide a substantially constant or long term actuation force and return force from the first actuation. FIG. 8 is a graph of measured actuation force and return force for actuations of an electroformed dome in accordance with some embodiments of the invention. Graph 800 includes horizontal axis 802 depicting actuations of a dome, and vertical axis 804 depicting a measured force. When a dome is actuated, the force required to depress the dome is measured and plotted on graph 800, and the return force of the dome when the pressing force is released is measured and plotted on graph 800.

The actuation force for an electroformed dome is measured for each actuation, and plotted as line 810 in graph 800. As can be seen from the substantially horizontal or flat line 810, the measured actuation force for the electroformed dome remains substantially constant for all actuations (e.g., measured at 460) of the electroformed dome. Because of this property, only a single measurement of the first actuation of an electroformed dome may suffice to determine whether the dome was constructed in a manner that satisfies the manufacturing specification. In addition, because of the consistency in deposition of material in the electroforming process, testing a single dome may suffice to test all of the domes constructed from a single mandrel. This may lead to substantial savings in time and money.

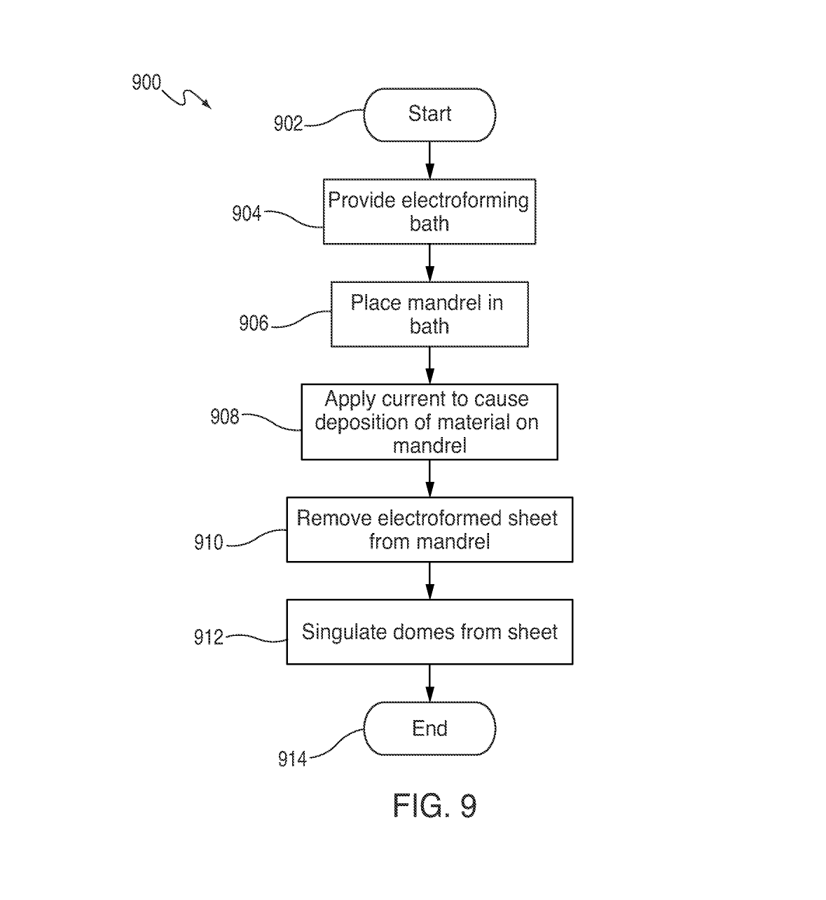

The following flowcharts describe illustrative processes for use in electroforming domes for use in dome switches. FIG. 9 is a flowchart of an illustrative process for electroforming a dome switch in accordance with some embodiments of the invention. Process 900 can begin at step 902. At step 904, an electroforming bath can be provided. For example, an apparatus for electroforming, including an anode of material to deposit (e.g., nickel) can be provided. At step 906, a mandrel can be placed in a bath. For example, a mandrel having dome shapes corresponding to domes for use in dome switches can be placed in the bath to serve as a cathode. At step 908, current can be applied to the electroforming bath to cause the deposition of material on the mandrel. For example, nickel particles can be transported from an anode to the mandrel forming a cathode in the bath. The nickel particles can be deposited on the mandrel to form a thin, self-supporting sheet that matches the shape of the mandrel. At step 910, the electroformed sheet can be removed from the mandrel. For example, a sheet having several electroformed domes can be removed from the mandrel. At step 912, the individual domes of the sheet can be singulated. For example, an etching process or a cutting process can be used to cut away each dome. Process 900 can then end at step 914.

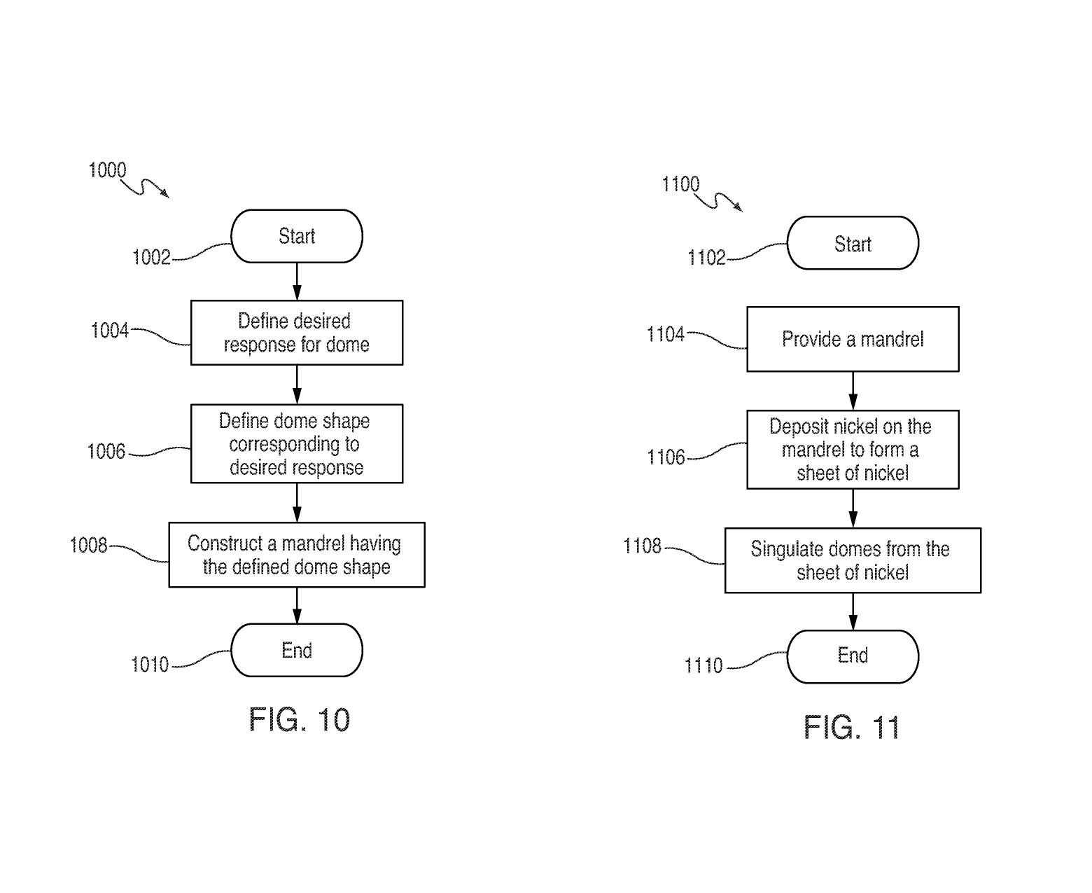

FIG. 10 is a flowchart of an illustrative process for constructing a mandrel for use in an electroforming process in accordance with some embodiments of the invention. Process 1000 can begin at step 1002. At step 1004, a desired response for a dome used in a dome switch can be defined. For example, a designer can determine a desired travel, actuation force, and response force for a dome switch used in an electronic device. At step 1006, a shape for a dome having the desired response can be determined. For example, analytical tools (e.g., finite element models) can be used to construct a particular dome shape. In some cases, the shape of the dome can depend on the particular material used for the dome, as well as the thickness of the dome. In some cases, however, the thickness of the dome can be a variable that may be determined by the analytical tools. For example, the analytical tools may be used to determine a dome shape and a dome thickness for a dome constructed by electroforming using nickel. At step 1008, a mandrel having the determined dome shape can be constructed. For example, a mandrel can be constructed such that at least one dome shape extends out of a planar surface to provide a three-dimensional structure. In some cases, the mandrel can be constructed to include several dome shapes extending from a planar surface, such that the mandrel can be used to electroform more than one dome at a time. Process 1000 can then end at step 1010.

FIG. 11 is a flowchart of an illustrative process for making an electroformed dome in accordance with some embodiments of the invention. Process 1100 can begin at step 1102. At step 1104, a mandrel can be provided. The mandrel can include a planar surface from which at least one three dimensional dome shape extends out of a plane of the planar surface. At step 1106, nickel may be deposited on the mandrel as part of an electroforming process. For example, nickel can be deposited to form a sheet of nickel having a shape corresponding to a shape of the planar surface and at least one three dimension dome shape. At step 1108, a portion of the sheet of nickel having a shape corresponding to the at least one three dimensional dome shape can be singulated. In particular, the portion can be separated from the nickel sheet to form a dome for use in a dome switch. Process 1100 can end at step 1110.

The above described embodiments of the present invention are presented for purposes of illustration and not of limitation, and the present invention is limited only by the claims which follow.

What is claimed is:

1. An electroformed dome for use in a dome switch, comprising:
an electroformed metal structure comprising:
a three dimensional dome shape having a substantially uniform thickness and is composed of at least 95% nickel.

2. The electroformed dome of claim 1, wherein:
the metal structure is composed of at least 98% nickel.

3. The electroformed dome of claim 1, wherein:
the thickness is in the range of 15 microns to 500 microns.

4. The electroformed dome of claim 1, wherein:
the thickness in the range of 15 microns to 30 microns.

5. The electroformed dome of claim 1, wherein:
the thickness of the metal structure varies plus or minus 500 nanometers.

6. The electroformed dome of claim 1, wherein the metal structure further comprises:
a nub disposed substantially adjacent to an apex of the metal structure.

7. The electroformed dome of claim 1, wherein the metal structure further comprises:
a closed periphery defining a single plane; and
wherein the three dimensional dome shape extends out of the single plane and wherein a transition between the single plane and the three dimensional dome shape is smooth.

8. The electroformed dome of claim 7, wherein:
the three dimensional shape comprises a spline rotated around an axis perpendicular to the single plane.

9. The electroformed dome of claim 7, wherein:
the three dimensional shape comprises a portion of a surface of a sphere.

10. The electroformed dome of claim 1, further comprising:
a coat of gold applied to a surface of the metal structure.

11. A sheet of electroformed snap domes, comprising:
a planar sheet having a uniform thickness and composed of at least 98% nickel;
a plurality of three dimensional dome shapes comprising a surface curved over three dimensions distributed on the planar sheet, wherein each of the plurality of three dimensional dome shapes has a uniform thickness equal to the thickness of the planar sheet, wherein the variation in thickness of the planar sheet and of the plurality of three dimensional dome shapes is less than 3 microns.

12. The sheet of claim 11, wherein:
the plurality of three dimensional dome shapes are distributed evenly on the planar sheet.

13. The sheet of claim 11, wherein:
the plurality of three dimensional dome shapes have the same dimensions and shape.

14. The sheet of claim 11, wherein:
the plurality of three dimensional dome shapes comprise a first set of dome shapes having a first size and a first shape, and a second set of dome shapes having a second size and a second shape.

15. The sheet of claim 14, wherein:
the first shape is different than the second shape.

16. The sheet of claim 14, wherein:
the first size is different than the second size.

17. A method for making an electroformed dome for use in a dome switch, comprising:
providing a mandrel comprising a planar surface from which at least one three dimensional dome shape extends out of a plane of the planar surface;
depositing nickel on the mandrel using an electroforming process to form a sheet of nickel having a shape corresponding to a shape of the planar surface and at least one three dimension dome shape; and
singulating the portion of the sheet of nickel having a shape corresponding to the at least one three dimensional dome shape to separate an electroformed dome from the sheet.

18. The method of claim 17, wherein singulating further comprises:
electrochemically etching the portion of the sheet of nickel to separate the electroformed dome from the sheet.

19. The method of claim 17, wherein singulating further comprises:
photo-etching the portion of the sheet of nickel to separate the electroformed dome from the sheet.

20. The method of claim 17, wherein singulating further comprises:
laser cutting the portion of the sheet of nickel to separate the electroformed dome from the sheet.
